(19) United States
(12) Patent Application Publication
(10) Pub. No.: US 2016/0221163 A1
(43) Pub. Date: Aug. 4, 2016

(54) OPEN END CONTINUOUS ROTATION RATCHET WRENCH

(71) Applicant: Frank Trucchio, Miami, FL (US)

(72) Inventor: Frank Trucchio, Miami, FL (US)

(21) Appl. No.: 14/612,953

(22) Filed: Feb. 3, 2015

(51) Int. Cl. B25B 17/00; B25B 13/46; B25B 13/08

(52) U.S. Cl. CPC B25B 17/00; B25B 13/08; B25B 13/463

(57) ABSTRACT

An open end ratchet wrench includes a housing defining a handle and a head surrounding an open mouth and a central axis of rotation. A carriage is rotatable about the central rotational axis and carries a moving jaw member for engaging a multi-sided element. A squeeze lever is operable to rotate the carriage and the moving jaw member continuously about the central rotational axis, selectively in either a clockwise or counterclockwise direction. An engagement assembly operates the moving jaw member between an operable position in engagement with the multi-sided element and a retracted release position, wherein the moving jaw member backs away from the central rotational axis to release from operative engagement with the multi-sided element. A switch operated carriage return assembly spins the carriage and moving jaw member to a start position to thereby allow removal of the wrench from the work piece.

### BACKGROUND OF THE INVENTION

1. Field of the Invention

The present invention relates to wrenches, and more particularly to an open end reversible ratchet wrench that is operable by squeezing a lever to rotate a moving jaw continuously about one or more complete 360° rotations relative to a central rotational axis of the mouth of the wrench in order to selectively advance or retreat a multi-sided nut element along a threaded element of a work piece, while maintaining the handle of the wrench stationary and without having to remove the wrench from the work piece.

2. Discussion of the Related Art

Open end wrenches are well known in the art and are typically defined by a head and elongate handle that is integral with the head. A jaw on the head of the wrench surrounds an open mouth that is usually positioned at a slight angle in relation to the handle. The open mouth is specifically sized for receiving a work piece for engagement with the inner surfaces of the jaw in a manner which allows rotation of the work piece upon applying torque using the handle. Most open end wrenches are structured for grasping and rotating a multi-sided element, such as a hex nut, in order to tightened or loosen the nut element on a threaded cylindrical element, such as a bolt shaft or other threaded member.

In the past, others have proposed various open end ratchet wrenches that typically include a rotating jaw. A ratchet is used to permit rotation in one direction while preventing rotation in the opposite direction. More particularly, the ratchet drives rotation of the jaw in a selected direction of rotation and blocks reverse rotation. In many instances, the ratchet cooperates with ratchet pawls that engage the ratchet. Examples of open end ratchet wrenches are disclosed in prior art patents, including the U.S. Patents to Stanton, U.S. Pat. No. 5,456,143; Sroka U.S. Pat. No. 5,388,479; Gamble U.S. Pat. No. 5,768,958; and Ashby, U.S. Pat. No. 5,467,672. These various open end ratchet wrenches fail to provide for both a moving jaw member and a fixed jaw member, wherein a double nut arrangement, such as in an in-line compression fitting, can be tightened or loosened. The above referenced open end ratchet wrenches also fail to provide for linear movement of the moving jaw member away from the central axis of rotation which would allow the moving jaw member to back off and release from operative engagement with the work piece so that the wrench can be removed from the work piece. My previous invention, as disclosed in U.S. Pat. No. 6,810,773, provides for theses features and advantages that are not found in the above referenced prior art wrenches.

Notwithstanding the benefits of my prior invention, there are instances wherein it is necessary to tightened or loosen either a single or double nut device in a tight, confined space, which requires continuous rotation of a nut element about one or more complete 360° rotations without having to remove the wrench from the nut element on the work piece. My prior invention, as disclosed in U.S. Pat. No. 6,810,773, allows for only limited rotation of the moving jaw member, either clockwise or counterclockwise about a turn of less than 360°. More particularly, the moving jaw member of my prior invention is not able to rotate continuously about a 360° path of rotation relative to the central rotational axis of the wrench mouth. Moreover, my prior invention fails to provide for a carriage return assembly that allows the moving jaw member to return to a start position, in open alignment with the mouth of the wrench, regardless of the rotated position that the moving jaw member is at just prior to returning to the start position.

Accordingly, there remains a need for an open end ratchet wrench that allows for selective rotation of a moving jaw member, either clockwise or counterclockwise through one or more complete 360° rotations, and which allows for linear movement of the moving jaw member away from the central axis of rotation of the wrench mouth while also allowing the moving jaw member to be returned to a start position in open alignment with the wrench mouth regardless of the rotated position of the moving jaw member.

### SUMMARY OF THE INVENTION

An open end ratchet wrench includes a housing defining a handle and a head with an open mouth surrounding a central axis of rotation. The open mouth is formed to include a multi-faceted fixed jaw for engaging a congruently configured element of a work piece, such as a first element of a compression fitting. A carriage is rotatable about the central rotational axis of the mouth of the wrench and carries a moving jaw member with a multi-faceted arrangement for engaging a congruently configured element, such as a second element of a compression fitting or any type of individual multi-sided element, such as a hex nut. A squeeze lever is operable to rotate the carriage and the moving jaw member continuously about the central rotational axis, selectively in either a clockwise or counterclockwise movement, to thereby tightened or loosen either a single nut on a threaded element, or a second multi-sided element relative to a first multi-sided element. An engagement assembly operates the moving jaw member between an operable position in engagement with a multi-sided element and a retracted release position, wherein the moving jaw member backs away from the central rotational axis to release from operative engagement with the multi-sided element. A switch operated carriage return assembly spins the carriage and moving jaw member to a start position, defined by alignment of the moving jaw member with the fixed jaw member and the open mouth of the wrench, to thereby allow removal of the wrench from the work piece.

### BRIEF DESCRIPTION OF THE DRAWINGS

For a fuller understanding of the nature of the present invention, reference should be made to the following detailed description taken in conjunction with the accompanying drawings in which:

FIG. 1 is a top perspective view of the open end ratchet wrench of the present invention;

FIG. 2 is a top plan view of the moving jaw member;

FIG. 3 is a bottom plan view of the moving jaw member;

FIG. 4 is a rear elevational view of the moving jaw member;

FIG. 5 is a top plan view of a top plate of the carriage assembly;

FIG. 6 is a top plan view of a first stage of the carriage assembly, normally positioned below the top plate, and including a sprocketed outer ring and an inner ring;

FIG. 7 is a top plan view of a second stage of the carriage assembly providing a spacer ring below the first stage;

FIG. 8 is a top plan view of a third stage of the carriage assembly including a ring with a stop member for stopping the return rotation of the carriage at the start position;

FIG. 9 is a top plan view of a lower gear member of the carriage assembly, providing a fourth stage for engagement with a carriage return assembly;

FIG. 10 is a top plan view of a toothed ring normally positioned in the first stage of the carriage assembly between the outer and inner rings;

FIG. 11 is a exploded side elevational view illustrating the functional arrangement between the moving jaw member, the top plate of the carriage assembly and the toothed ring for engaging and releasing the moving jaw member from the advanced, operative position to a retracted, release position;

FIG. 12 is a top plan view of the wrench, shown with a top portion of the housing, a squeeze lever and other components removed in order to illustrate various component elements with the housing of the wrench, including an arc shield for selectively controlling operational move of the moving jaw member between a clockwise rotation, a counterclockwise rotation and neutral mode and a loader finger for tightening a spin gear against a coil spring force assembly upon squeeze operation of the lever;

FIG. 13 is a top view of the spin gear carriage return assembly;

FIG. 14 is an exploded arrangement of the component parts of a plunging arm assembly;

FIG. 15 is a top plan view of the plunging arm assembly;

FIG. 16 is an exploded view showing the arc shield and a primary thumb switch;

FIG. 17 is an exploded top plan view of the lever and rotational pawls for engaging the sprocketed ring of the carriage assembly in order to selectively rotate the carriage assembly in either the clockwise or counterclockwise direction;

FIG. 18 is an exploded perspective view showing a further embodiment of the moving jaw member including a removable insert to change the wrench size of the moving jaw member; and

FIG. 19 is an isolated perspective view showing the wrench size adjustment insert received within the moving jaw member, and also a fixed jaw member that is adapted to receive a similar wrench size adjustment insert.

Like reference numerals refer to like parts throughout the several views of the drawings.

### DETAILED DESCRIPTION OF THE PREFERRED EMBODIMENT

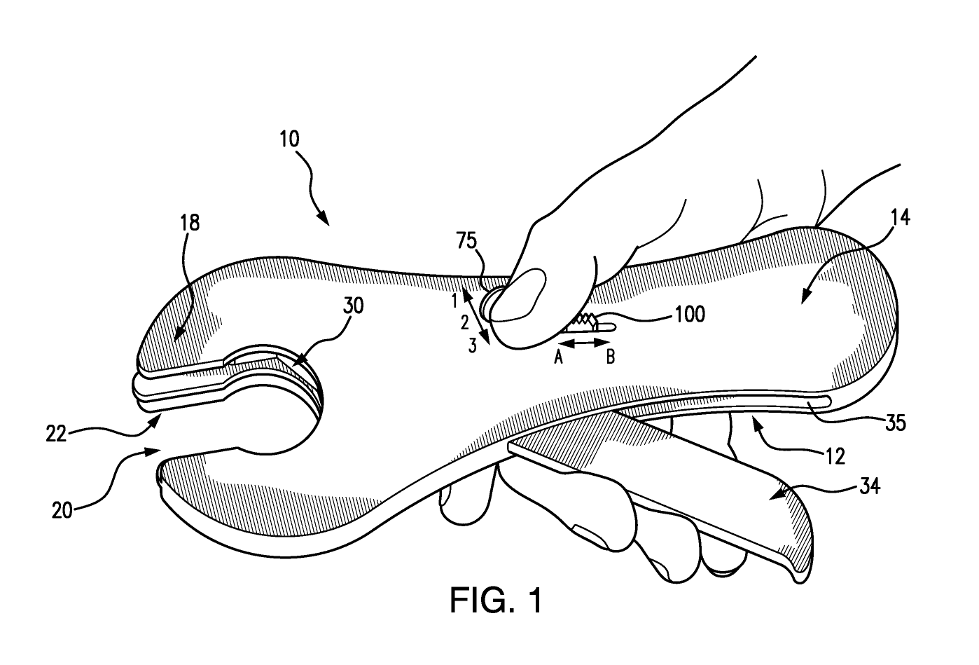

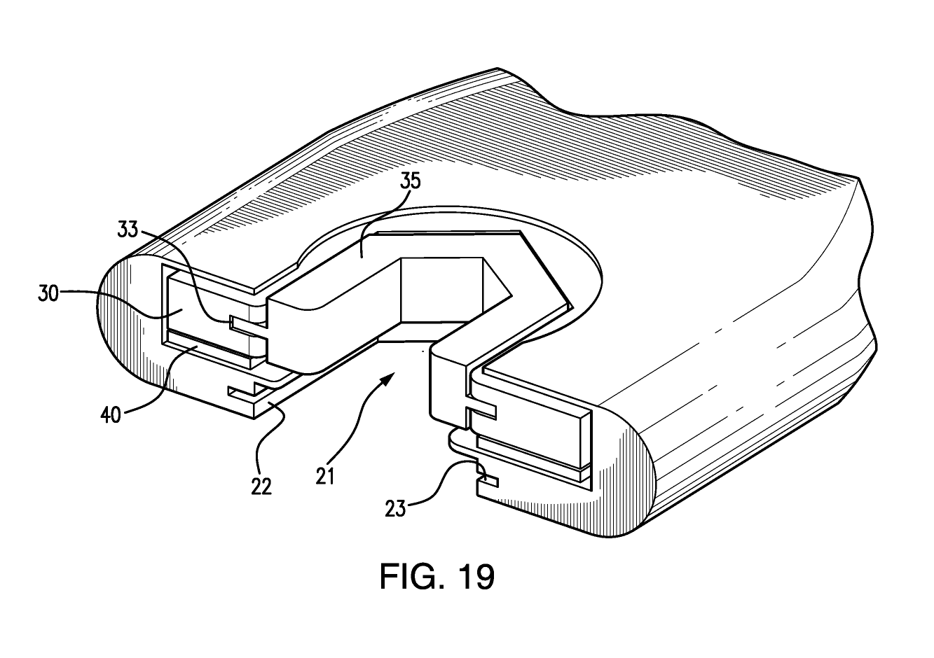

Referring to the several views of the drawings, the open end ratchet wrench of the present invention is shown and is generally indicated as 10. As shown in FIG. 1, the wrench 10 includes a housing 12 defined primarily by a handle portion 14 and an integrally formed head 18 including an open mouth 20. In a preferred embodiment, the housing is formed to include a fixed jaw member 22. As best seen in FIG. 19, the fixed jaw member 22 surrounds about the wrench mouth and has a multi-faceted configuration for engaging a first element of a work piece. The fixed jaw member 22 may also include slots 23 for receiving an insert jaw member providing for wrench size adjustment, wherein the spacing between the multi-faceted sides is changed to accommodate different sizes of a work piece, such as different hex nut sizes.

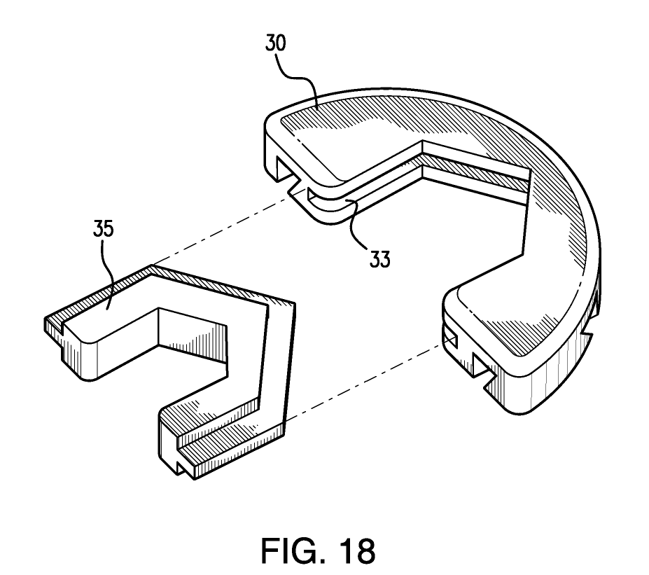

Referring to FIGS. 18 and 19, the wrench 10 further includes a moving jaw member 30 movably positionable within the mouth 20. The moving jaw member 30 is carried on a rotatable carriage 40 that allows complete 360° rotation of the moving jaw member 30 about a central longitudinal axis 21 extending through the mouth 20 of the wrench. The moving jaw member 30 includes a multi-faceted configuration for operative engagement on a multi-sided element of a work piece, such as a hex nut or fitting. Similar to the fixed jaw member 22, the moving jaw member may be provided with slots 33 for receiving an insert jaw member 35 for wrench size adjustment.

The rotational capability of the carriage 40 allows the moving jaw member 30 to remain on the multi-sided element (e.g. hex nut, or fitting) while rotating the multi-sided element continuously, as needed, to advance or retreat the multi-sided element along a threaded element while the handle 14 of the wrench is held stationary and a squeeze lever 34 of the wrench is continuously operated. The carriage assembly 40 is specifically structured for rotating the moving jaw member 30 in either a clockwise or counterclockwise rotational direction for an unlimited number of complete 360° rotations, while the moving jaw member 30 remains engaged on the multi-sided element of the work piece.

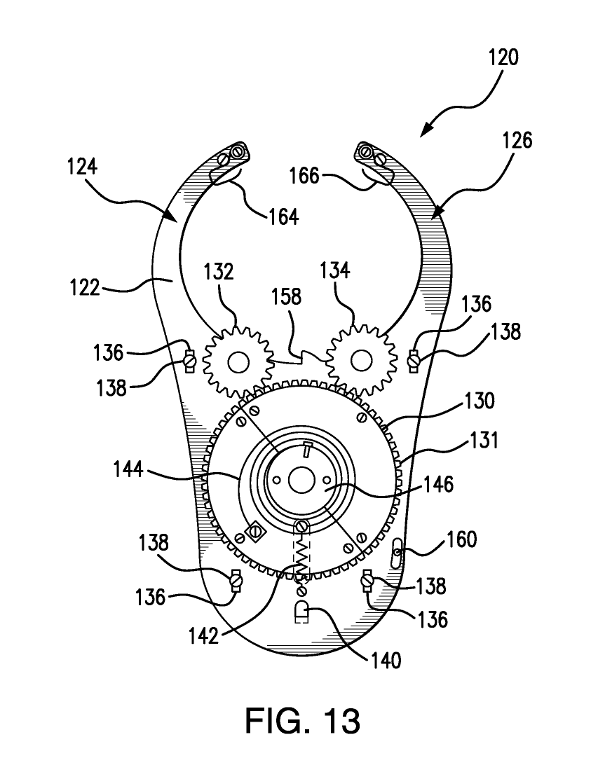

The moving jaw member 30 is slideably carried on the carriage assembly 40 and is movable between a retracted position, wherein the moving jaw member 30 is backed away from the multi-sided element of the work piece, and an advanced, operative position, wherein the moving jaw member 30 is moved inwardly towards the central rotational axis of the wrench mouth and into engagement with the multi-sided element of the work piece. The carriage assembly 40 is also selectively engaged with a carriage return assembly 120 (see FIG. 13) in order to return the carriage 40 and moving jaw member 30 to a start position, wherein the facets of the moving jaw member 30 are aligned with the facets of the fixed jaw 22 and the mouth of the moving jaw is aligned with the open mouth 20 of the wrench, thereby allowing the wrench 10 to be completely removed from the work piece.

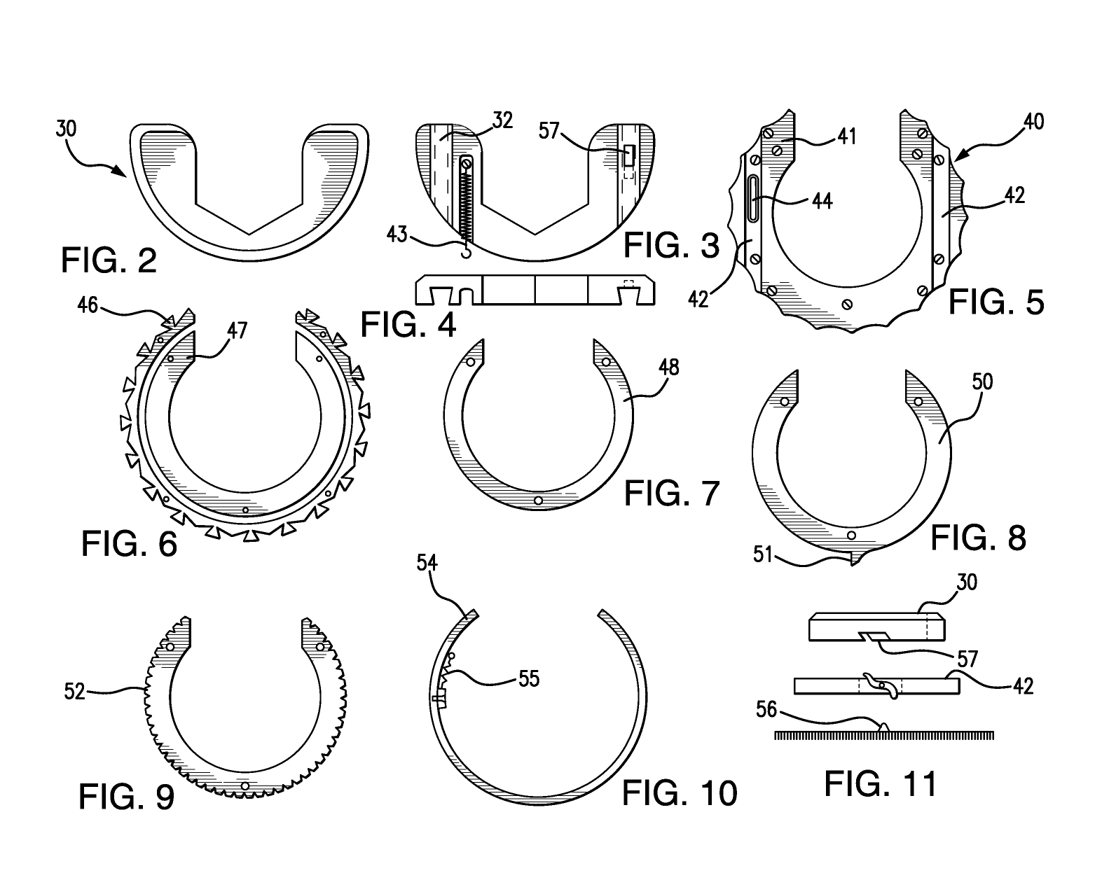

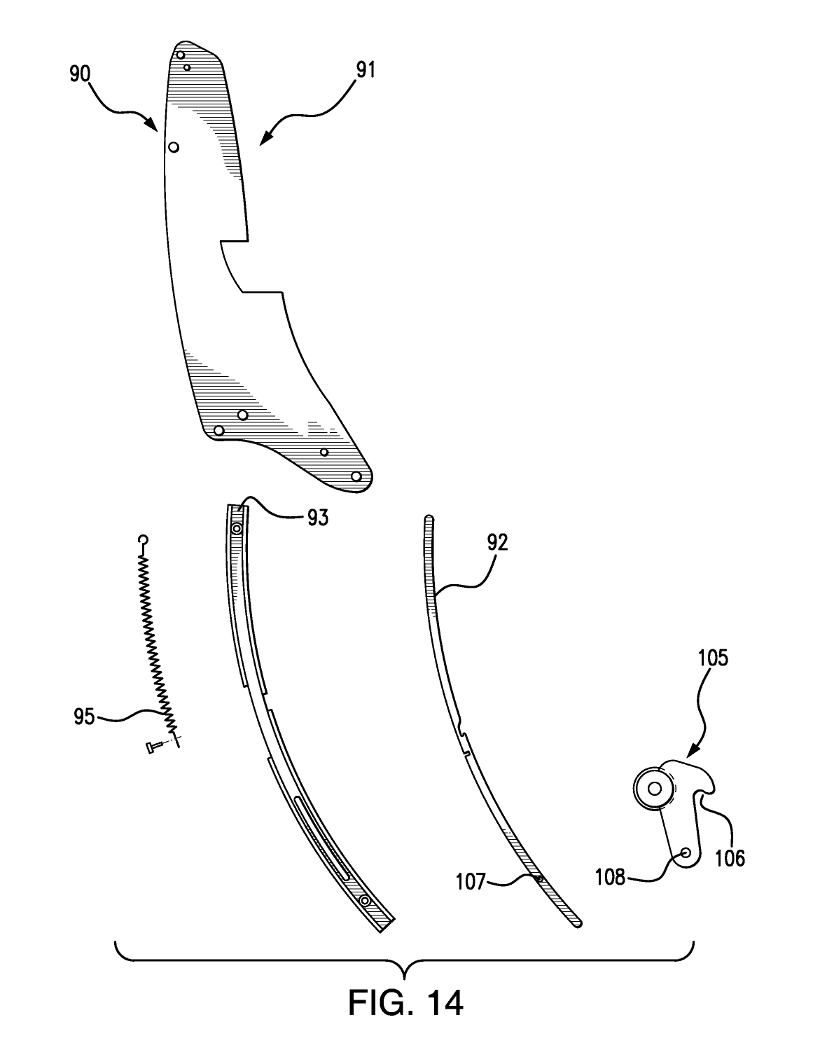

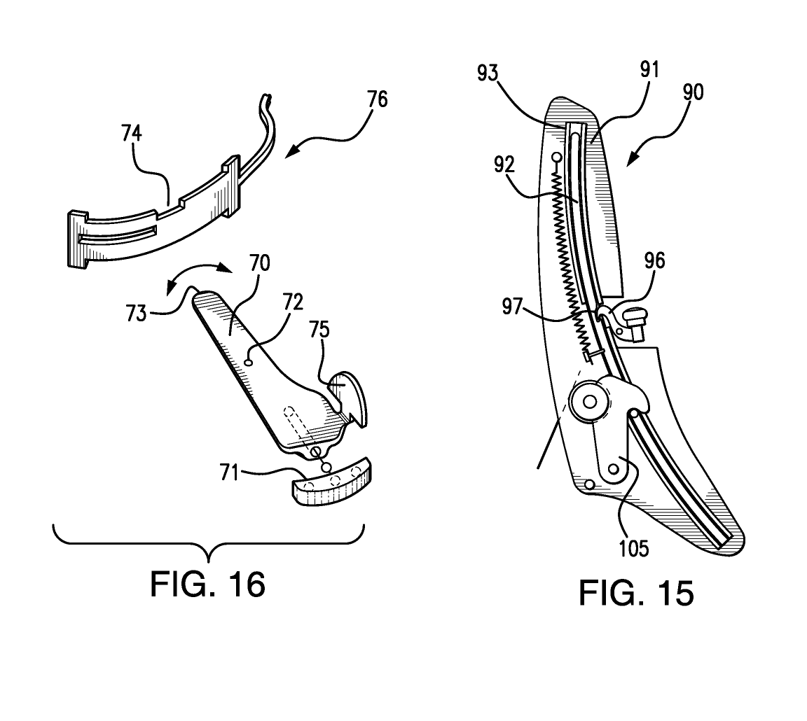

The moving jaw member 30 is slidable on dove tail guide rails 42 on a top plate 41 of the carriage 40 (see FIGS. 3-5). More particularly, the dove tail guide rails 42 are received within congruently configured grooves 32 formed on a bottom side of moving jaw member 30. A spring 43 connects between the moving jaw member 30 and the carriage 40 to urge the moving jaw member to the retracted release position, wherein the moving jaw member 30 is backed away from the central rotational axis 21 of the mouth of the wrench. Operation of a plunging arm 92 (see FIGS. 14-15), as described more fully hereinafter, urges the moving jaw member 30 against the spring 43 and into locked engagement with a recessed finger 44 in the carriage assembly, to thereby hold the moving jaw member in the advanced, operative position. A sprocketed outer ring 46 and inner ring 47 (see FIG. 6) comprise a first stage of the carriage assembly and are fitted below the top plate of the handle 14. A second stage of the carriage assembly, positioned below the inner ring 47, provides a spacer ring 48 (see FIG. 7) that functions to engage friction springs on the wrench mouth, as described further hereinafter. The third stage of the carriage assembly provides a ring 50 with a stop member 51 (see FIG. 8) for stopping rotation of the carriage 40 at the start position following actuation of the carriage return assembly 120. A fourth stage of the carriage provides for a gear member 52 (see FIG. 9) for engagement with the carriage return assembly 120 to allow the carriage assembly and moving jaw member 30 to spin back to the start position. A toothed ring 54 is received between the sprocketed outer ring 46 and the inner ring 47 in the first stage of the carriage. The toothed ring 54 is retained by a spring 55 (see FIG. 10) which allows limited arc movement of the toothed ring relative to a remainder of the carriage assembly. The toothed ring 54 includes a bump 56 (see FIG. 11) on its top surface for engaging a pivoting finger 44 on the top plate 41 of the carriage assembly 40 in order to move the pivoting finger 44 downwardly and out of engagement with a recess 57 in the bottom of the moving jaw member, thereby allowing ejection spring 43 to pull the moving jaw member 30 to the retracted release position.

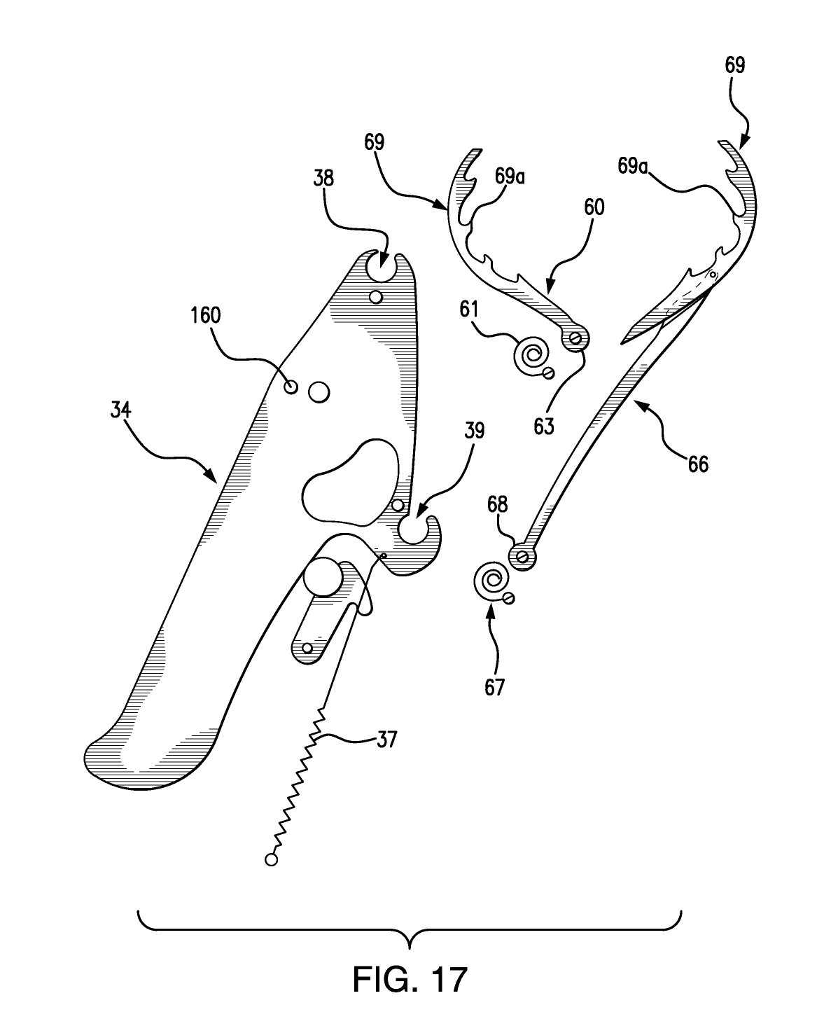

Rotation of the carriage 40 and moving jaw member 30 is achieved by squeeze operation of the lever 34. The lever 34 is pivotally fitted within an interior of the housing of the wrench and extends outwardly from a side of the wrench at a normally relaxed position. Squeeze operation moves the lever inwardly towards the side of the wrench and within a slotted opening 35 along the side of the wrench housing 12. A lever return spring 37 (see FIG. 17) connected between the lever 34 and the inner housing of the wrench returns the lever 34 to the relaxed position, defined by the lever 34 extending outwardly from the side of the wrench at an angle of approximately 40°. Referring to FIG. 17, a clockwise pawl 60 is fitted to a top end 38 of the lever 34 and is urged inwardly towards the wrench mouth by spring 61 which connects between a lower end of the pawl 63 and the top end 38 of the lever 34. A counterclockwise pawl 66 is fitted to a mid-portion 39 of the lever 34 and is urged inwardly, towards the mouth of the wrench by a spring 67 connected between a lower end 68 of the counterclockwise pawl 66 and the mid-portion 39 of the lever 34. Both the clockwise pawl 60 and the counterclockwise pawl 66 are provided with teeth 69a on arcuate pawl arms 69 for engaging the sprocketed outer ring 46 of the carriage assembly 40 in order to drive rotation of the carriage assembly either clockwise or counterclockwise, upon squeezing the lever 34. Specifically, when the clockwise pawl 60 is engaged with the sprocketed outer ring 46 of the carriage assembly 40 and the lever 34 is squeezed, the clockwise pawl 60 urges the carriage assembly in the clockwise rotational direction which, in turn, rotates the moving jaw member 30 about the central rotational axis 21 of the mouth in the clockwise direction. Similarly, when the teeth 69a of the counterclockwise pawl 66 are engaged with the sprocketed outer ring 46 of the carriage assembly 40 and the lever 34 is squeezed, the counterclockwise pawl 66 is moved to drive rotation of the carriage assembly in the counterclockwise direction which, in turn, rotates the moving jaw member 30, in the counterclockwise rotational direction about the central rotational axis 21 of the wrench mouth.

Referring to FIGS. 1 and 16, a primary thumb switch 70 is operated to control selection of the rotation of the carriage 40 and moving jaw member 30 in either the clockwise or counterclockwise directions. The primary thumb switch 70 is operable between three positions, including a right position for counterclockwise rotation, a left position for clockwise rotation, and a center neutral position. A ball bearing and detent block 71 allow the thumb switch 70 to be selectively moved and held in the selected position. The primary thumb switch 70 is mounted on a central pivot pin 72 and includes a forwardly extending finger 73 that is received within a notch 74 in the arc shield 76. The arc shield 76 is slidable around an arc of movement relative to the mouth of the wrench. Pivoting movement of the primary thumb switch 70, by pushing the primary thumb switch tab 75 either to the right or the left, moves the forwardly projecting finger 73 of the thumb switch 70 to urge the arc shield 76 to the left or to the right. When the projecting tab 75 of the primary thumb switch, on the top of the wrench, is moved to the first position (i.e. to the right) the forwardly projecting finger 73 of the thumb switch moves to push the arc shield 76 to the left, thereby disengaging the clockwise pawl 60 from the sprocketed outer ring 46 of the carriage assembly 40 and moving the counterclockwise pawl 66 into engagement into the sprocketed outer ring 46. Upon subsequent squeeze and release operation of the lever 34, the counterclockwise pawl 66 will drive rotation of the carriage assembly 40 and the moving jaw 30 in the counterclockwise rotational direction. Movement of the projecting tab 75 on the primary thumb switch 70 to the left position urges the arc shield 76 to the right, thereby disengaging the counterclockwise pawl 66 from the sprocketed outer ring 46 of the carriage assembly 40 and allowing the spring 61 of the clockwise pawl 60 to urge the clockwise pawl into engagement with the sprocketed outer ring 46 of the carriage 40. Upon subsequent squeeze and release operation of the lever 34, the clockwise pawl 60 drives rotation of the carriage assembly 40 and the moving jaw 30 in the clockwise rotational direction about the central rotational axis 21 of the wrench mouth. It is important to note that the toothed arms 69 of the clockwise and counterclockwise pawls are longer than the mouth (i.e. gap) of the moving jaw member 30 to thereby allow the pawls 60, 66 to always remain in at least partial engagement with the sprocketed outer ring 46 on the carriage so that the carriage 40 can be continuously rotated in either direction.

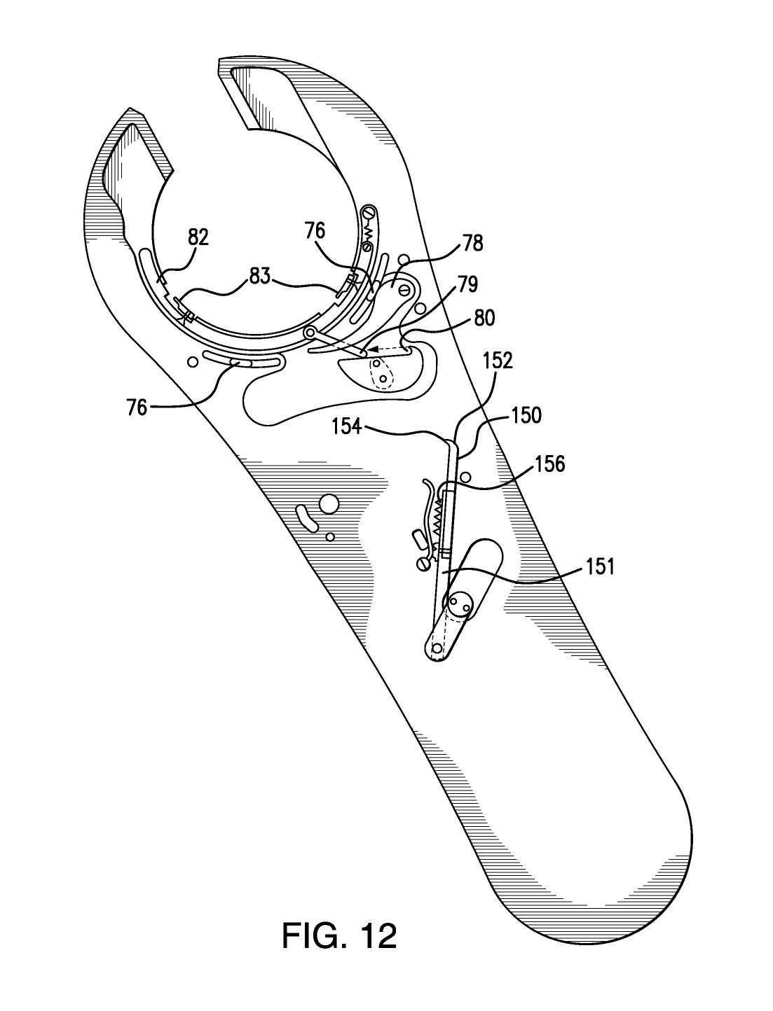

Movement of the projecting tab 75 of the primary thumb switch 70 to the center position serves to move the arc shield 76 to a neutral position, wherein both the clockwise pawl 60 and the counterclockwise pawl 66 are disengaged from the carriage assembly 40. Referring to FIG. 12, movement of the primary thumb switch 70 to the neutral position further causes the arc shield 76 to move an advancing inhibitor finger 78 against a spring force of a pivoting push rod 79 that is received through a slotted arrangement of the advancing and inhibiting finger. Movement of the pivoting push rod 79, in this neutral position, aligns the pivoting push rod 79 with an advancing finger 80 on the top end of the lever 34. Upon squeeze operation of the lever 34 from a normally relaxed position to the squeezed position, with the primary thumb switch 70 the neutral position, the advancing finger 80 pushes the pivoting pushrod 79 which, in turn, urges an activator bar 82 through a short arc of movement. This causes spring loaded jaw ejection fingers 83 on the activating bar 82 to rise and engage the toothed ring 54 on the carriage, urging the toothed ring 54 against the spring 55 and moving the bump 56 on top of the toothed ring against the jaw holder finger 44 to disengage the holder finger 44 from the moving jaw member 30, and thereby allowing the moving jaw member 30 to retract to the released position in response to the force of the jaw ejection spring 43.

In addition to releasing the moving jaw member 30 from the work piece, the engagement assembly is operable to move the moving jaw member 30 back to the advanced, operable position for engagement on the multi-sided element of the work piece. Specifically, the engagement assembly includes a plunging arm assembly 90 supported on a plate 91 within the wrench, as shown in FIGS. 14-15. The plunging arm assembly 90 includes a sleeve 93 for containing a plunging arm 92 against the force of a spring 95 connecting between the plunging arm 92 and the mounting plate 91. The spring 95 is arranged to urge the plunging arm 92 outwardly from a forward end of the sleeve and into contact with a rear portion of the moving jaw member 30 to thereby push the moving jaw member 30 inwardly relative to the central location axis 21 of the wrench mouth 20. More particularly, the plunging arm 92 applies a force to the rear face of the moving jaw member 30 to cause the moving jaw member to slide on the dove tail guide rails 42 of the carriage assembly 40 until the jaw holder finger 44 engages the recess 57 on the bottom side of the moving jaw member 30. With the holder finger engaged within the recess 35, the moving jaw member 30 is releasably locked in the advanced, operable position.

The plunging arm 92 is normally loaded within the sleeve 93, against the force of the spring 95, and held by a hooked tip 97 of a pivoting claw 96. To fire the plunging arm 92 forwardly, thereby returning the moving jaw member 30 to the operable position, the secondary thumb switch 100 is pushed forward towards the mouth of the wrench (see FIG. 1). This causes a leg 102 of the secondary thumb switch 100 to move a pivoting element 103, against the force of a spring 104, which, in turn, and causes the claw 96 to pivot and release the hooked tip 97 from the engagement with the plunging arm 92. Once the hooked tip 97 is released from the plunging arm 92, the spring 104 immediately pulls the plunging arm 92 forward in a rapid shooting action. The forward distal tip of the plunging arm 92 strikes the rear face of the moving jaw member 30, forcing the moving jaw member forwardly, in rapid movement, to the advanced, operable position, wherein the jaw holder finger 44 catches the recess 57 on the bottom of the moving jaw member 30 (see FIGS. 3 and 5). Upon the next successive squeeze operation of the lever 34, the plunging arm 92 is reloaded within the sleeve 93 and locked into the loaded position by the claw 96 which is normally urged into interlocking engagement with the plunging arm 92 by the spring loaded pivoting element 103. Specifically, a roller element 105 on the squeeze lever 34 engages the back edge of a plunging arm loader hook 106. The plunging arm loader hook 106 grabs a pin 107 extending perpendicularly from a rear portion of the plunging arm 92. By squeezing the lever 34, the roller 105 pushes the plunging arm loader hook 106 about a pivot pin 108 which, in turn pulls the pin 107 on the plunging arm 92 back and retracts the plunging arm 92 into the sleeve 93. When the plunging arm 92 is fired, the plunging arm loader hook 106 serves to stop the plunging arm 92 in its forward movement so that the plunging arm 92 does not fully exit the sleeve.

As noted above, a carriage return assembly 120 functions to spin the carriage assembly 40 and the moving jaw member 30 back to the start position so that the wrench can be placed onto or moved from the work piece. When it is desired to spin the carriage 40 assembly and moving jaw member 30 back to the start position, the secondary thumb switch 100 is moved backwards, away from the mouth of the wrench. Backwards movement of the secondary thumb switch 100 causes the leg 102 to trip a catch element 110 which normally holds the carriage return assembly 120 in a stowed position. The carriage return assembly 120 is mounted on a plate 122 that includes opposite arched arms 124,126 structured and disposed to surround the mouth of the wrench, within the wrench housing. The carriage return assembly plate 122 accommodates a main spin gear 130 and a pair of secondary spin gears 132,134 drivingly engaged with the teeth 131 of the main spin gear 130. The plate 122 of the carriage return assembly 120 is mounted within the housing and is longitudinally movable a limited distance. Specifically, mounting slots 136 on the plate 122 are specifically sized and positioned to limit forward and rearward movement of the plate. Screws 138 are received through the slots 136 and are fixed to the housing, allowing the plate 122 of the carriage return assembly 120 to move as defined by the length of the slots 136 relative to the permitted movement of the mounting screws 138 within the slots. In the retracted, stowed position, the pivoting catch member 110 is engaged within an aperture 140 in the rear of the plate 122. A spring 142 connecting between the plate 122 of the carriage return assembly and the housing 12 urges the entire carriage return assembly 120 forward, limited by the permitted movement of the mounting screws 138 within the longitudinal slots 136. The catch member 110 holds the plate 122 in the stowed position, against the force of the spring 142.

Referring to FIGS. 12 and 13, the main spin gear 130 of the carriage return assembly 120 is loaded against the force of a flat coil spring 144 that connects at one end to the plate 122 and an opposite end to a hub 146 fitted to the main spin gear 130 about its center rotational axis. The hub 146 serves to rotatably mount the main spin gear 130 to the plate 122. With each squeeze operation of the lever 34 of the wrench, a spring biased spin gear loader finger 150 is pulled. The tip 152 of a spring gear loader finger 150 engages the outer toothed surface 131 of the main spin gear 130 to rotate the main spin gear 130 against the force of the flat coil spring 144 with each squeeze of the main operating lever 34 of the wrench. A spin gear holder spring element 154 also engages in the main spin gear 130 to hold the main spin gear 130 against the wound coil force of the flat coil spring 144 after each rotational loading movement as the loader finger 150 is pulled to rotate and load the main spin gear 130 with each squeeze operation of the lever. Eventually, the flat coil spring 144 becomes fully loaded and the spring biased spin gear loader finger 150 yields to a force of a relief spring 156 upon further squeeze operation of the lever. Specifically, rather than rotating the main spin gear 130 when the flat coil spring 144 is fully loaded, the spin gear loader finger 150 nearly extends out from a spring loader tube 151 with each squeeze operation of the wrench lever, and then returns to its normal, relaxed position, due to the force of the relief spring 156, as the lever 34 of the wrench is released back to its relaxed position. This prevents overloading of the flat coil spring 144.

When it is desired to return the carriage assembly 40 and moving jaw member 30 to the start position, the moving jaw member 30 is first retracted to the release position, in the manner described above. Next, the secondary thumb switch 100 is pushed backwards, away from the mouth of the wrench, to trip the catch element 110, thereby releasing the plate 122 of the carriage return assembly 120. This also releases the spin gear holder spring element 154 and the spring gear loader finger 150 from engagement with the main spin gear 130. Accordingly, the entire carriage return assembly 40 moves forward in rapid action, while the main spin gear 130 is rotated due to the recoil action of the loaded flat coil spring 144. Rotation of the main spin gear 130 serves to drivingly rotate the secondary spin gears 132,134. With the carriage assembly 40 moved to the forward, operable position, the secondary spin gears 132,134 engage the lower gear ring 52 on the carriage assembly 40, thereby spinning the entire carriage assembly 40 until the rotating stop member 51 on the third stage of the carriage assembly strikes a fixed stop member 158 on the carriage return assembly plate 122, thereby stopping and holding the carriage assembly 40 in the start position with the moving jaw member 30 aligned with the open mouth 20 of the wrench. Upon the next successive squeeze operation of the wrench lever 34, a spin plate loading pin 160 connecting to the lever pulls the plate 122 of the carriage return assembly 120 back, against the force of the spring 142, until the catch element 110 engages within the aperture 140 of the plate 122, thereby holding the carriage return assembly 120 in the stowed position. In this position, friction springs 164,166 at the forward distal ends of the arch arms 124,126 of the plate engage the second stage spacer ring 48 of the carriage assembly 40 to prevent free rotation of the carriage assembly 40 and moving jaw member 30.

While the present invention has been shown and described in accordance with preferred and practical embodiments thereof, it is recognized that departures from the instant disclosure are fully contemplated within the spirit and scope of the invention.

What is claimed is:

1. An open end ratchet wrench comprising:
a housing surrounding an inner cavity and including a handle portion and a head portion at a distal end of said handle portion, and said head portion having an open mouth defined by a fixed jaw member surrounding a central longitudinal axis of rotation;
a moving jaw member having a multi-faceted configuration for operative engagement of a multi-sided element, and said moving jaw member being selectively positionable between an advanced, operative position within the open mouth of said head portion and a retracted, release position;
a rotatable carriage assembly sized and configured for slideably carrying said moving jaw member between the advanced, operative position and the retracted, release position, and said rotatable carriage assembly being structured and disposed for allowing 360° rotation of said moving jaw member about the central longitudinal axis while said moving jaw member remains engaged on the multi-sided element when in the advanced, operative position;
said rotatable carriage assembly including a sprocketed outer ring;
a lever having a distal end pivotally fitted within the inner cavity of said housing and a proximal end extending outwardly from said housing in a normally relaxed position is provided for operating continuous rotation of said carriage assembly, and said lever being urged into the relaxed position by a lever return mechanism connected between said lever and an inner facing surface of said housing; and
a first pawl rotatably fitted to said lever and having a plurality of teeth sized for engaging said sprocketed outer ring of said carriage assembly in order to drive rotation of said carriage assembly in a first direction when said lever is squeezed.

2. The open end ratchet wrench as recited in claim 1 further comprising:
a second pawl rotatably fitted to said lever and having a plurality of teeth sized for engaging said sprocketed outer ring of said carriage assembly in order to drive rotation of said carriage assembly in a second, opposite direction when said lever is squeezed; and
a primary thumb switch structured and disposed for controlling selection of the direction of rotation of said carriage assembly and said moving jaw member when said lever is squeezed, and said primary thumb switch being selectively positionable between a first position for engaging said first pawl and a second position for engaging said second pawl.

3. The open end ratchet wrench as recited in claim 2 wherein said rotatable carriage assembly further comprises:
a top plate having guide rails sized and configured for congruent receipt within grooves formed on a bottom side of said moving jaw member;
a spring between said moving jaw member and said carriage assembly that is configured for urging said moving jaw member into the retracted position;
a plunging arm assembly for normally forcing said moving jaw member against the force of said spring and into locked engagement with a recessed finger in the advanced position;
a lower gear ring; and
a stop member.

4. The open end ratchet wrench as recited in claim 3 wherein said primary thumb switch is positionable in a neutral, third position for disengaging said recessed finger from said moving jaw member and thereby allowing said moving jaw member to retract in response to the force of said spring when said lever is squeezed.

5. The open end ratchet wrench as recited in claim 4 further comprising a carriage return assembly structured and disposed for rotating and moving said carriage assembly and said moving jaw member from the advanced, operative position to the retracted, release position such that said moving jaw member is in a starting position that is defined by said moving jaw member being in alignment with the open mouth of the head portion, and said carriage return assembly being selectively operable by a user.

6. The open end ratchet wrench as recited in claim 5 further comprising a secondary thumb switch structured and disposed for controlling selection of movement of said moving jaw member into the advanced, operative position and the retracted, release position, and said secondary thumb switch being selectively positionable between a first position for moving said moving jaw member into the advanced, operative position by firing said plunging arm forwardly and a second position for moving said moving jaw member into the refracted, release position.

7. The open end ratchet wrench as recited in claim 6 wherein said carriage return assembly comprises:
a plate including opposing arched arms sized and configured to surround the mouth of the wrench;
a main spin gear;
a first secondary spin gear and a second secondary spin gear, each of said first and second secondary spin gears being drivingly engaged with said main spin gear;
a flat coil spring having a first end connected to said plate and a second end connected to said main spin gear about its center rotational axis, and said flat coil spring being structured and disposed to supply force against said main spin gear;
a fixed stop member; and
wherein said secondary thumb switch being selectively positioned in the second position when said lever is squeezed causes said first and second secondary spin gears to engage with said lower gear ring for rotating said carriage assembly until said stop member on said carriage assembly contacts said fixed stop member to thereby position said moving jaw member in alignment with the open mouth of the head portion.

8. The open end ratchet wrench as recited in claim 1 wherein said lever return mechanism is a lever return spring.

9. An open end ratchet wrench comprising:
a housing surrounding an inner cavity and including a handle portion and a head portion at a distal end of said handle portion, and said head portion having an open mouth surrounding a central longitudinal axis of rotation;
a moving jaw member having a multi-faceted configuration for operative engagement of a multi-sided element;
a rotatable carriage assembly being structured and disposed for allowing 360° rotation of said moving jaw member about the central longitudinal axis while said moving jaw member remains engaged on the multi-sided element, and said rotatable carriage assembly comprising:
a top plate;
a sprocketed outer ring and inner ring fitted below said top plate;
a lower gear ring; and
a stop member;
a lever having a distal end pivotally fitted within the inner cavity of said housing and a proximal end extending outwardly from said housing in a normally relaxed position is provided for operating continuous rotation of said carriage assembly, and said lever being urged into the relaxed position by a lever return mechanism connected between said lever and an inner facing surface of said housing;
a clockwise pawl rotatably fitted to said lever and having a plurality of teeth sized for engaging said sprocketed outer ring of said carriage assembly in order to drive clockwise rotation of said carriage assembly when said lever is squeezed;
a counter clockwise pawl rotatably fitted to said lever and having a plurality of teeth sized for engaging said sprocketed outer ring of said carriage assembly in order to drive counter clockwise rotation of said carriage assembly when said lever is squeezed; and
a primary thumb switch structured and disposed for controlling selection of the direction of rotation of said carriage assembly and said moving jaw member when said lever is squeezed, and said primary thumb switch being selectively positionable for engaging one of said clockwise and counterclockwise pawls.

10. The open ratchet wrench as recited in claim 9 wherein said moving jaw member is selectively positionable between an advanced, operative position within the open mouth of said head portion and a retracted, release position, and wherein said rotatable carriage assembly sized and configured for slideably carrying said moving jaw member between the advanced, operative position and the retracted, release position.

11. The open ratchet wrench as recited in claim 10 further comprising a spring between said moving jaw member and said carriage assembly that is configured for urging said moving jaw member into the retracted position.

12. The open ratchet wrench as recited in 11 wherein said top plate includes guide rails sized and configured for congruent receipt within grooves formed on a bottom side of said moving jaw member.

13. The open end ratchet wrench as recited in claim 12 wherein said primary thumb switch is positionable in a neutral, third position for disengaging said recessed finger from said moving jaw member and thereby allowing said moving jaw member to retract in response to the force of said spring when said lever is squeezed.

14. The open end ratchet wrench as recited in claim 13 further comprising a carriage return assembly structured and disposed for rotating and moving said carriage assembly and said moving jaw member from the advanced, operative position to the retracted, release position such that said moving jaw member is in a starting position that is defined by said moving jaw member being in alignment with the open mouth of the head portion, and said carriage return assembly being selectively operable by a user.

15. The open end ratchet wrench as recited in claim 14 further comprising a secondary thumb switch structured and disposed for controlling selection of movement of said moving jaw member into the advanced, operative position and the retracted, release position, and said secondary thumb switch being selectively positionable between a first position for moving said moving jaw member into the advanced, operative position by firing said plunging arm forwardly and a second position for moving said moving jaw member into the retracted, release position.

16. The open end ratchet wrench as recited in claim 15 wherein said carriage return assembly comprises:
a plate including opposing arched arms sized and configured to surround the mouth of the wrench;
a main spin gear;
a first secondary spin gear and a second secondary spin gear, each of said first and second secondary spin gears being drivingly engaged with said main spin gear;
a flat coil spring having a first end connected to said plate and a second end connected to said main spin gear about its center rotational axis, and said flat coil spring being structured and disposed to supply force against said main spin gear;
a fixed stop member; and
wherein said secondary thumb switch being selectively positioned in the second position when said lever is squeezed causes said first and second secondary spin gears to engage with said lower gear ring for rotating said carriage assembly until said stop member on said carriage assembly contacts said fixed stop member to thereby position said moving jaw member in alignment with the open mouth of the head portion.

17. The open end ratchet wrench as recited in claim 9 wherein said lever return mechanism is a lever return spring.

18. The open end ratchet wrench as recited in claim 9 wherein the open mouth of said head portion is defined by a fixed jaw member.
